(19) United States
(12) Patent Application Publication
(10) Pub. No.: US 2022/0314508 A1
(43) Pub. Date: Oct. 6, 2022

(54) METHOD AND SYSTEM OF DELIVERING ADDITIVES FOR MOLDING

(71) Applicant: 3M INNOVATIVE PROPERTIES COMPANY, St. Paul, MN (US)

(72) Inventors: Ramnath Subramaniam, North Oaks, MN (US); Jason D. McNulty, Stillwater, MN (US)

(21) Appl. No.: 17/753,442

(22) PCT Filed: Aug. 27, 2020
(86) PCT No.: PCT/IB2020/058026

§ 371 Date: Mar. 3, 2022

Related U.S. Application Data
(60) Provisional application No. 62/896,159, filed on Sep. 5, 2019.

(51) Int. Cl. B29C 45/18

(52) U.S. Cl. CPC B29C 45/1816; B29C 2045/185; B29C 2945/76083; B29C 2945/7611; B29C 2945/76187; B29C 2945/76351; B29C 2945/76367; B29C 2945/76545; B29C 2945/76812; B29C 2945/76829; B29C 2945/76846; B29C 2945/76933

(57) ABSTRACT

Methods and systems of delivering liquid additives in a molding system are provided. A charging sensor is provided to monitor the status of the injection charging mechanism of the molding system which charges, meters or doses an injection volume of molding material. A dosing instruction is generated based on the charging status signal. The additive pump controls the delivering of the liquid additives into the injection unit based on the dosing instruction, while the injection charging mechanism is charging the injection volume of molding material.

### BACKGROUND

In injection molding, raw materials can be fed into an injection unit, mixed and injected into a mold cavity, where the materials can cool and harden to the configuration of various molded articles. For example, thermoplastic resin pellets can be fed through a hopper into the heated barrel with a reciprocating screw.

### SUMMARY

Briefly, in one aspect, the present disclosure describes a method of delivering one or more liquid additives to a molding system. The method includes delivering, via an additive pump, the liquid additives into an injection unit of the molding system. The injection unit includes an injection charging mechanism to charge an injection volume of molding material. The method further includes monitoring, via a charging sensor, a status of the injection charging mechanism, to generate a charging status signal representing a charging state of the injection volume of molding material; processing, via a microcontroller, the charging status signal to generate a dosing instruction to the additive pump; and controlling, via the additive pump, the delivering of the liquid additives into the injection unit based on the dosing instruction while the injection charging mechanism is charging the injection volume of molding material.

In another aspect, the present disclosure describes a system of delivering one or more liquid additives to a molding system. The system includes an additive pump configured to deliver the liquid additives into an injection unit of the molding system. The injection unit includes an injection charging mechanism to charge an injection volume of molding material. A charging sensor is configured to monitor a status of the injection charging mechanism and generate a charging status signal. A microcontroller is provided to process the charging status signal and generate a dosing instruction to control, via the additive pump, the delivering of the liquid additives into the injection unit based on the dosing instruction.

Various unexpected results and advantages are obtained in exemplary embodiments of the disclosure. One such advantage of exemplary embodiments of the present disclosure is that the methods and systems provided with a proprietary closed loop control can precisely and accurately deliver liquid additives and reactants to molding systems. For example, when a screw of an injection unit slips, the dispensing system can automatically detect the screw slippage and adjust the dispensing rate accordingly.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic diagram of an injection molding system, according to one embodiment.

FIG. 2 illustrates screw dosing profiles showing screw position versus time, according to one embodiment.

FIG. 3 is a block diagram of an injection molding system, according to one embodiment.

FIG. 4A illustrates an exemplary additive dispenser to dispense liquid additives into the injection unit, according to one embodiment.

FIG. 4B is an exploded view of the additive dispenser of FIG. 4A.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “injection molding” refers to a molding process or system where one or more materials or any precursors thereof are injected or otherwise introduced into a closed or substantially closed mold cavity under pressure and the materials or precursors can take the shape of the cavity to form a molded article.

The term “injection charging mechanism” refers to an internal component of an injection molding system which facilitates the introduction of material into a mold cavity of the injection molding system. For example, an injection charging mechanism can be disposed inside an injection unit, charge a volume of material from a feed throat of an injection unit into the mold cavity for a molding cycle, and control the flowrate or volume of the material. A typical injection charging mechanism includes, for example, a reciprocating screw, a plunger, a piston, or any combination thereof.

The term “liquid additive” refers to a variety of liquids having a wide range of viscosities and containing one or more additives such as, for example, monomers, agents, catalysts, cements, colorants, coatings, detergents, epoxies, dyes, fillers (e.g., body filler), nano-materials, oils, paints (e.g., automotive paints), pastes, pigments, polymer additives (which may be organic or inorganic), sealants, stains, toners, varnishes, waxes, etc. The liquid additive may be neat (including concentrates) or in the form of a dispersion, suspension or solution. The liquid may have a viscosity, for example, less than about 30,000 centipoise (mPa-s), less than about 20,000 centipoise (mPa-s), or less than about 15,000 centipoise (mPa-s) at a temperature of about 21° C.

By using terms of orientation such as “atop”, “on”, “over”, “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture.

The terms “about” or “approximately” with reference to a numerical value or a shape means +/− five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof Various exemplary embodiments of the disclosure will now be described with particular reference to the Drawings.

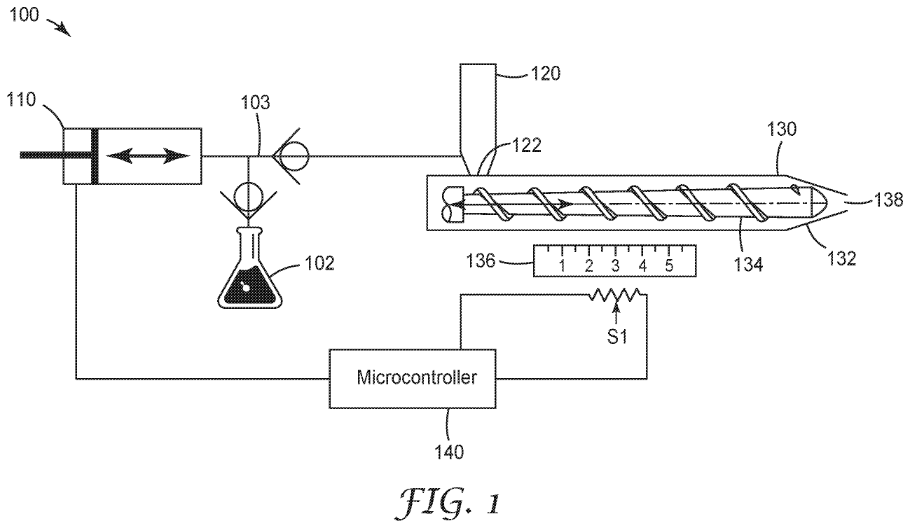

FIG. 1 is a schematic diagram of an injection molding system 100, according to one embodiment. The injection molding system 100 includes a hopper 120 to receive materials to be molded. In some embodiments, plastic materials can be supplied to the hopper 120 in the form of small pellets. In some embodiments, additives can be mixed into the materials to be molded in the hopper 120. In some embodiments, the mixed materials can be gravity-fed from the hopper 120 through a feed throat 122 into an injection unit 130. In some embodiments, the hopper 120 may include a blender that can mix multiple materials to be molded. In some embodiments, the hopper 120 may include a static mixer to receive and mix liquid materials under a pressure, for example, up to about 7000 psi or grater, up to about 6000 psi or grater, from about 1000 psi to about 7000 psi, or from about 2000 psi to about 6000 psi.

The injection molding system 100 further includes an additive pump 110 to deliver one or more liquid additives 102 into the injection unit 130. The additive pump 110 is connected to the injection unit 130 via suitable fluid connections and valves 103. In some embodiments, the additive pump 110 can first deliver the liquid additives 102 in an auxiliary equipment such as, for example, a blender, where thermoplastic materials can be mixed with the liquid additives. In some embodiments, the additive pump 110 can directly deliver the liquid additives 102 into the hopper 120, where thermoplastic materials are received. In some embodiments, the additive pump 110 can deliver the liquid additives 102 into the injection unit 130 via the feed throat 122 beneath the hopper 120, while thermoplastic materials are delivered via the hopper 120. In some embodiments, the additive pump 110 can deliver the liquid additives 102 into a static mixer under a pressure, where liquid materials can be mixed with the liquid additives 102 before being delivered into the injection unit 130. In some embodiments, the additive pump 110 can deliver the liquid additives 102 directly into a mold cavity connected to the injection unit 130 via a nozzle 138.

In some embodiments, the additive pump 110 can be a positive displacement pump such as, for example, a syringe pump to deliver additives into the injection unit 130. A suitable positive displacement pump can be, for example, rotary, reciprocating, or linear style. Exemplary rotary type pumps include a gear pump, a screw pump, a rotary vane pump, any combinations thereof, etc. Exemplary reciprocating pumps include a plunger or syringe pump, a piston pump, a diaphragm pump, a circumferential piston pump, any combinations thereof, etc. Exemplary linear pumps include a rope pumps, a chain pump, any combinations thereof, etc. The positive displacement pump can deliver the liquid additives into the feed throat under a pressure, for example, up to about 7000 psi or grater, up to about 6000 psi or grater, from about 1000 psi to about 7000 psi, or from about 2000 psi to about 6000 psi.

The reciprocating injection unit 130 includes a barrel 132 to support an injection charging mechanism 134 received therein. In the depicted embodiment of FIG. 1, the injection charging mechanism 134 includes a reciprocating screw. The reciprocating screw 134 can be used to compress, melt, and convey the material to be molded. In some embodiments, the reciprocating injection unit 130 may include multiple zones including, e.g., a feeding zone, a compression zone, and a metering zone. The materials can feed into the feeding zone from the hopper 120 or the feed throat 122. In the compression zone, decreasing volume flights of the reciprocating screw 134 can compress the materials against the inside diameter of the barrel 132, provide shear heat and melt the materials. The reciprocating injection unit 130 may further include one or more heaters to maintain the materials in the molten state. The molten material can be delivered by the reciprocating injection unit 130 into a mold cavity via the nozzle 138.

The reciprocating injection unit 130 further includes a charging sensor 136 to monitor the status of the screw 134 including, for example, position, rotation, velocity, acceleration, or other operation parameters of the screw 134. In some embodiments, the charging sensor 136 may include a strain gauge such as, for example, an extension potentiometer that outputs a variable signal based on displacement of an extension mechanism which is coupled to the screw 134. For example, the extension potentiometer may have a string connected to a moving component of the injection unit 130 such as a hydraulic cylinder positioning the of the screw 134. The extension potentiometer may output a 0 V DC signal when the string is at full extension, and a 10 V DC signal when the string is fully retracted. When the screw 134 moves to inject the molten material into the mold, the signal may decrease (e.g., to a value between 10 V and 0 V). Near the end of the molding cycle, the injection unit 130 charges, meters or doses the next shot volume. Here, the shot volume refers to the volume of plastic that is melted and prepared for the next cycle. To do this, the screw may rotate, conveying plastic materials forward of the screw tip, causing the screw 134 to retract in the injection unit 130. Accordingly, the string of the potentiometer retracts, causing the signal to increase (e.g., to a value between 0 V to 10 V).

The charging sensor 136 can generate a charging status signal S1 based on the monitored status of the screw 134. A microcontroller 140 receives the charging status signal S1 from the charging sensor 136 and processes the signal S1 to determine the status of the screw 134 and the charging state of injection molding materials inside the injection unit 130. For example, the microcontroller 140 can determine the injection volume or flowrate of the molding material to be charged based on the status of the screw 134. The microcontroller 140 can further determine the charging status signal to generate a dosing instruction to the additive pump 110, including determining a flowrate of the liquid additives to be delivered by the additive pump 110 into the injection unit 130. The additive pump 110 receives the dosing instruction and controls the delivering of the liquid additives into the injection unit based on the dosing instruction, while the screw 134 is charging the injection volume of molding material.

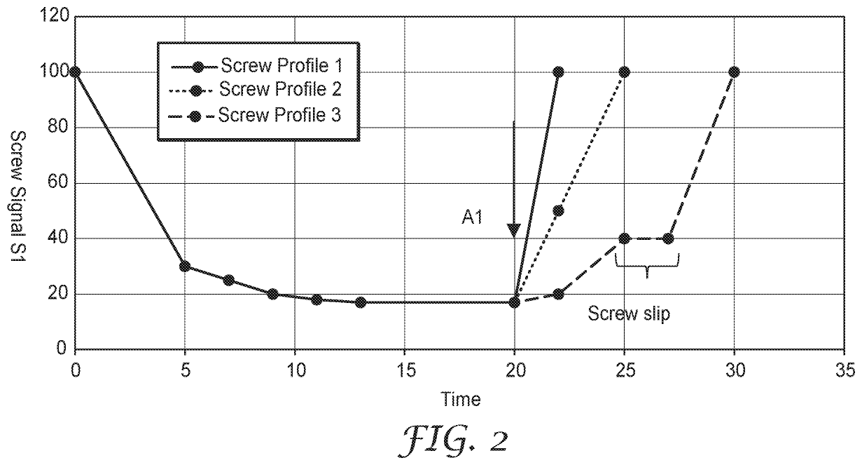

FIG. 2 shows plots of exemplary screw charging or dosing profiles obtained by possessing the status signal S1 from the charging sensor 136. As illustrated in the embodiment of FIG. 2, the screw dosing profiles 1-3 each represent a real-time monitored screw position of the screw 134 within the injection unit 130. When the microcontroller 140 identifies an increase of the signal S1, it instructs the additive pump 110 to dispense. The microcontroller 140 may not allow the additive pump 110 to dispense until the charging status signal S1 changes. When the microcontroller 140 detects that the charging status signal S1 changes, the microcontroller 140 can instruct the additive pump 110 to dispense at a rate which is correlated to the derivative (rate of change) of the charging status signal S1.

For example, as shown in FIG. 2, near the end of the molding cycle (e.g., at the time of 20 seconds as indicated by the arrow A1), the injection unit 130 starts to charge, meter or dose the next shot volume. The screw 134 can rotate, conveying plastic materials forward of the screw tip, causing the screw 134 to retract in the injection unit 130 (i.e., an increase of the screw position). Accordingly, the string of the potentiometer retracts, causing the signal to increase (e.g., to a value between 0V to 10V). The microcontroller 140 may not allow the additive pump 110 to dispense until the end of the molding cycle. For the screw charging/dosing profile 1, the potentiometer provides a quickly increasing signal (e.g., starting at the time of about 20 seconds as indicated by the arrow A1); and the microcontroller 140 instructs the additive pump 110 to dispense at a high volumetric flowrate based on the signal. For the screw charging/dosing profile 2, the potentiometer provides a slowly increasing signal (e.g., starting at the time of about 20 seconds as indicated by the arrow A1); and the microcontroller 140 instructs the additive pump 110 to dispense at a low volumetric flowrate based on the signal. For the screw charging/dosing profile 3, the potentiometer provides an even slower increasing signal (e.g., starting at the time of about 20 seconds as indicated by the arrow A1); and the microcontroller 140 instructs the additive pump 110 to dispense at an even lower volumetric flowrate based on the signal.

When the screw 134 rotates in the injection unit 130 to charge, meter or dose the next shot volume, the screw 134 may slip and the plastic material may cease to feed into the injection unit 130. If the additive pump 110 continues to dispense when the screw 134 slips, this may result in erroneous dispensing ratios (e.g., the concentration ratio of additives and plastic material). Such a screw slip is illustrated in FIG. 2, where there is a plateau in the screw charging/dosing profile 3 which corresponds to a screw slippage.

In some embodiments, the microcontroller 140 can receive the real-time charging status signal S1 from the charging sensor 136, process the signal to generate a dosing instruction to the additive pump 110, including determining a flowrate of the liquid additives to be delivered by the additive pump 110 into the injection unit 130.

In some embodiments, the microcontroller 140 can receive the real-time charging status signal S1 from the charging sensor 136, process the signal to obtain a screw charging/dosing profile, and analyze the screw charging/dosing profile to determine whether the screw 134 slips or not. When the microcontroller 140 determines that the screw 134 starts to slip, the microcontroller 140 instructs the additive pump 110 to stop dispensing immediately. When the microcontroller 140 determines that the screw slippage ends, the microcontroller 140 determines a volumetric flowrate based on the signal and instructs the additive pump 110 to dispense at the determined volumetric flowrate.

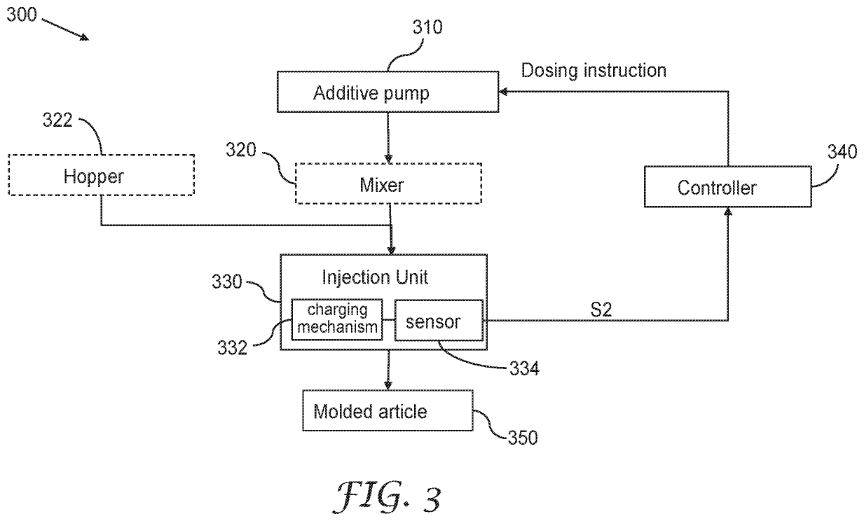

FIG. 3 illustrates a block diagram of an injection molding system 300, according to one embodiment. The injection molding system 300 includes an additive pump 310 to dispense one or more liquid additives to an injection unit 330. In various embodiments, the liquid additives may include, for example, reactive monomers, low molecular weight or low viscosity agents, catalysts, etc. Exemplary additives include colorants, plasticizers, flame retardants, adhesion promoters, etc.

In some embodiments, an optional mixer 320 can be provided to mix the liquid additives into materials to be molded. The liquid additives may include, for example, a photocure initiator, a reaction catalyst, a thermal initiator, etc. Initiators may include, for example, peroxides, diazo compounds, etc. Catalysts may include various polymerization catalysts such as, for example, those incorporating Tin compounds, etc. Reactive raw materials may include, for example, silanes, vinylsilanes, thiol-ene compounds, etc. Other suitable additives may include, for example, adhesion promoters etc. In some embodiments, a curing agent, an initiator, a reactive additive, or any combinations thereof can be provided as an additive to mix with liquid materials. For example, the additive pump 310 can dispense additives to the mixer for injection molding of liquid silicone rubber (LSR) which requires intensive distributive mixing. It is to be understood that the additive pump can dispense any suitable liquid additives for a molding process for molding any suitable materials, including, for example, a photo-curable material, a thermo-curable material, etc.

Reactive materials for injection molding can be precisely dispensed via a dispensing unit (not shown in FIG. 3) into a static mixer at a pressure in the range, for example, between 1000 and 1200 psi (6.89 to 8.27 MPa) to control the concentration of reactant in the molded articles. At the same time, the flowrate of the liquid additives can be precisely controlled by the additive pump 310. The additive pump 310 can be a positive displacement pump to deliver the liquid additives into the mixer under a high pressure in the range, for example, up to about 7000 psi or grater, up to about 6000 psi or grater, from about 1000 psi to about 7000 psi, or from about 2000 psi to about 6000 psi.

In some embodiments, the additive pump 310 can be an additive dispenser to dispense liquid additives into the injection unit 330 via a feed throat thereof. Thermoplastic pellets can be delivered into the injection unit 330 via an optional hopper 322 connected to a feed throat of the injection unit 330.

The injection unit 330 includes an injection charging mechanism 332 which facilitates the introduction of material from the feed throat of the injection unit 330 into a closed cavity of the injection molding system to form a molded article 350. The injection charging mechanism 332 is also configured to control the flowrate or volume of material to be charged for a molding cycle. A typical injection charging mechanism includes a reciprocating screw, a plunger, a piston, or any combination thereof, that can be disposed inside an injection unit.

In some embodiments, the injection charging mechanism 332 can include a screw to compress, melt, and/or convey the material to be molded. An example of such a screw is illustrated in FIG. 1 as the screw 134. It is to be understood that the injection charging mechanism 332 can be any types of screw, piston, plunger or other suitable mechanisms that can be used to control the flowrate or volume of material to be charged for the next molding cycle. A charging sensor 334 is provided to monitor the status of the screw 332 including, for example, position, rotation, velocity, acceleration, or other operation parameters of the screw 134 relating to the flowrate or volume of material to be charged. One example of the charging sensor 334 is illustrated in FIG. 1 as the charging sensor 136. It is to be understood that the charging sensor 334 can be any suitable types of sensor configured to monitor the status of the screw 332.

The charging sensor 334 can generate a charging status signal S2 based on the monitored status of the screw 332. A controller 340 receives the screw status signal S2 from the charging sensor 334 and processes the signal S2 to determine the status of the screw 332 and the charging state of injection molding materials inside the injection unit 310. For example, the controller 340 can determine the injection volume or flowrate of the molding material to be charged based on the status of the screw 332. The controller 340 can further determine the charging status signal to generate a dosing instruction to the additive pump 310, including determining a flowrate of the liquid additives to be delivered by the additive pump 310 into the injection unit 330. The additive pump 310 then controls the delivering of the liquid additives into the injection unit 330 based on the dosing instruction, while the screw 134 is charging the injection volume of molding material in the injection unit 330.

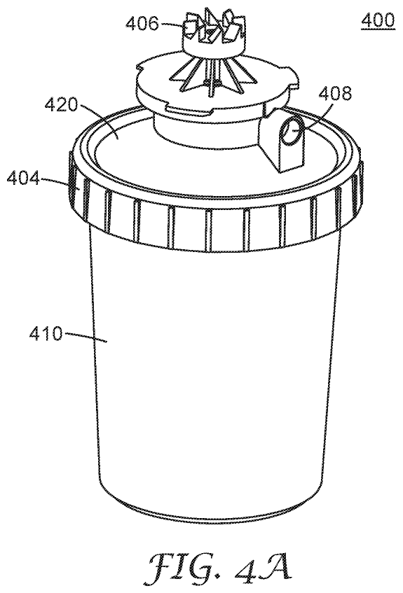

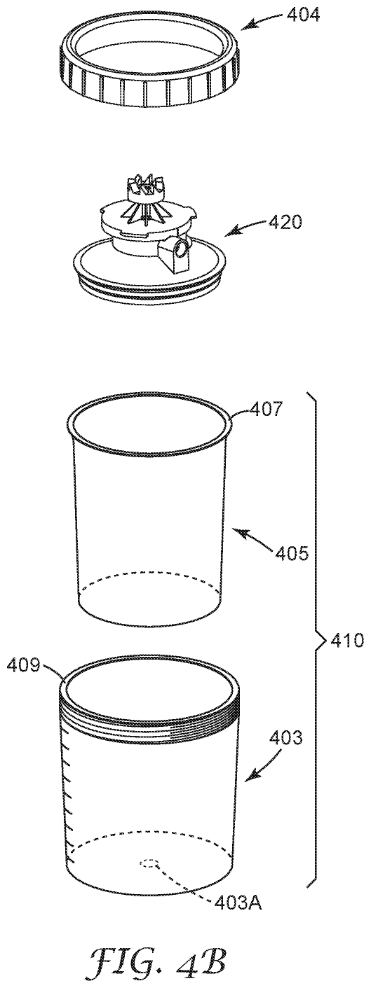

FIG. 4A illustrates an exemplary additive dispenser 400 to dispense liquid additives into the injection unit 330, according to one embodiment. FIG. 4B is an exploded view of the additive dispenser 400 of FIG. 4A. Methods and systems of dispensing liquids from an additive dispenser include a container coupled to an integrated pump cap are described in U.S. Patent Publication No. 2013/027030, which is incorporated herein by reference.

In some embodiments, the additive dispenser 400 can first deliver liquid additives in an auxiliary equipment such as, for example, a blender, where thermoplastic materials can be mixed with the liquid additives. In some embodiments, the additive dispenser 400 can directly deliver liquid additives into a hopper (e.g., 120 in FIG. 1), where thermoplastic materials are received. In some embodiments, the additive dispenser 400 can deliver liquid additives into an injection unit (e.g., 130 in FIG. 1) via a feed throat (e.g., 122 in FIG. 1) beneath the hopper (e.g., 120 in FIG. 1), while thermoplastic materials are delivered via the hopper.

The additive dispenser 400 includes a liquid container 410 with an integrated pump cap 420. The liquid container 410 includes a rigid reusable or disposable outer container 403, and a disposable flexible liner 405 positioned within the outer container. The outer container can provide structural stability when transporting the liquid container 410. The outer container can be removably coupled to the integrated pump cap 420, for example, using a threaded ring 404. The threaded ring 404 can be integral to the cap or a separate piece. The threads on ring 404 can be either male or female with the complementary mating threads formed on the outer container. The threaded ring 404 can also be used to maintain the position of the integrated pump cap 420 on the container 410. Although threaded ring 404 is illustrated in FIG. 4A for removably coupling integrated pump cap 420 to container 410, other coupling mechanisms may be employed such as, for example, a bayonet connector, snap tabs or snap wings, and the like, which may be useful for providing a “quick connect” capability. Alternatively, integrated pump cap 420 may be coupled to container 410 by an interference or friction fit between these two components.

The integrated pump cap 420 may be coupled to the rigid outer container 403 or the flexible liner 405. The coupling mechanisms described above are particularly suited for joining the pump to the rigid outer container. Additional stability can be obtained by, for example, forming the liner with a rim 407 at its open end that rests on the upper edge 409 of the outer container 403. Securing the integrated pump cap to the outer container by the techniques mentioned above may compress the rim of the liner between the upper edge of the outer container and the pump cap.

If integrated pump cap 420 is coupled to the flexible liner this may be accomplished by a friction fit between the pump cap and the liner or by sealing pump cap 420 to the liner using, for example, sonic welding or an adhesive.

As shown in FIG. 4B, the outer container 403 may contain an air hole 403A that remains open or an air hole that can be opened and closed with, for example, a strip of tape or a valve. In this way, when the air hole 403A is open, the inner liner 203 may collapse as liquid is pumped from the container thereby facilitating dispensing all of the liquid. Thus, the flexible inner liner in combination with the pump cap provides a sealed liquid container that collapses as the liquid is dispensed. This ventless construction allows for an air tight dispensing that reduces the risk of contamination to the liquid. For example, some liquids can react with oxygen, e.g., liquids that cure when exposed to air. Other liquids can easily be contaminated by particulates in the air which can impair their function and also interfere with the dispensing. The flexible liner can be composed of various flexible materials, for example, low density polyethylene.

Although the liquid container 410 is described as including an outer container and an inner liner, it may be a single component in the form of a container without a liner. The container that may be rigid or flexible and may contain a vent to equilibrate the pressure inside the container with atmospheric pressure when the vent is open. A flexible container may be composed of various flexible polymeric materials, for example, low density polyethylene or, if more strength or durability is desired, an EVA (ethylene vinyl acetate) resin such as one under the trade designation of Elvax.

The integrated pump cap 420 includes a motor coupler 406 that, in the illustrated embodiment, rotates about a central axis in response to a corresponding rotation of a drive component in a motor base (not shown). As shown, the motor coupler 406 includes a number of teeth that can engage a corresponding set of teeth in the motor base. Thus, when the motor drives a rotational drive shaft coupled by the teeth to the motor coupler 406, the motor coupler 406 is rotated to drive the pump so that contents of the container 410 can be dispensed through an output port 408. The teeth can be shaped to facilitate transfer of energy from the motor to the pump. Numerous variations on this approach are possible. For example, the motor coupler 406 and a motor base may have the same number of engagement teeth or a different number of engagement teeth, or they may interact without the use of gears that mesh such as by frictional engagement or magnetic coupling. For simplicity and ease of design, it is preferred to have the motor transfer rotational energy to the drive shaft but linear energy transfer can be used too via, for example, a rack and pinion mechanism. Advantageously, the pump cap 420 may be readily disassembled from a motor base without using tools so as to facilitate cleaning and installation of a different container 410.

The operation of the present disclosure will be further described with regard to the following embodiments. These embodiments are offered to further illustrate the various specific and preferred embodiments and techniques. It should be understood, however, that many variations and modifications may be made while remaining within the scope of the present disclosure.

### Listing of Exemplary Embodiments

It is to be understood that any one of embodiments 1-10 and 11-20 can be combined. Embodiment 1 is a method of delivering one or more liquid additives to a molding system, comprising:

delivering, via an additive pump, the liquid additives into an injection unit of the molding system, wherein the injection unit includes an injection charging mechanism to charge an injection volume of molding material;

monitoring, via a charging sensor, a status of the injection charging mechanism, to generate a charging status signal representing a charging state of the injection volume of molding material;

processing, via a microcontroller, the charging status signal to generate a dosing instruction to the additive pump; and

controlling, via the additive pump, the delivering of the liquid additives into the injection unit based on the dosing instruction while the injection charging mechanism is charging the injection volume of molding material.

Embodiment 2 is the method of embodiment 1, wherein generating the dosing instruction comprises determining a flowrate of the liquid additives to be delivered into the injection unit.

Embodiment 3 is the method of embodiment 1 or 2, wherein the charging sensor includes a strain gauge configured to monitor a position, a velocity, or an acceleration speed of the injection charging mechanism.

Embodiment 4 is the method of any one of embodiments 1-3, wherein processing the charging status signal further comprises determining the injection volume of the molding material to be charged.

Embodiment 5 is the method of any one of embodiments 1-4, further comprising mixing, via a mixer, the liquid additives with one or more molding materials, wherein the liquid additives are delivered to the mixer.

Embodiment 6 is the method of any one of embodiments 1-5, wherein the additive pump includes a positive displacement pump to deliver the liquid additives under a pressure in the range of about 2000 to 6000 psi.

Embodiment 7 is the method of any one of embodiments 1-6, wherein the injection charging mechanism includes one or more of a screw, a plunger, or a piston.

Embodiment 8 is the method of any one of embodiments 1-7, further comprising delivering, via a hopper, one or more thermoplastic molding materials into the injection unit.

Embodiment 9 is the method of embodiment 8, wherein the additive pump includes an additive dispenser to dispense the liquid additives into the injection unit.

Embodiment 10 is the method of any one of embodiments 1-9, wherein the one or more liquid additives include a colorant, a plasticizer, a flame retardant, or an adhesion promoter.

Embodiment 11 is a system of delivering one or more liquid additives to a molding system, comprising:

an additive pump configured to deliver the liquid additives into an injection unit of the molding system, wherein the injection unit includes an injection charging mechanism to charge an injection volume of molding material;

a charging sensor configured to monitor a status of the injection charging mechanism and generate a charging status signal; and

a microcontroller to process the charging status signal and generate a dosing instruction to control, via the additive pump, the delivering of the liquid additives into the injection unit based on the dosing instruction.

Embodiment 12 is the system of embodiment 11, wherein the microcontroller determines a flowrate of the liquid additives to be delivered into the injection unit.

Embodiment 13 is the system of embodiment 11 or 12, wherein the charging sensor includes a strain gauge configured to monitor a position, a velocity, or an acceleration speed of the injection charging mechanism.

Embodiment 14 is the system of any one of embodiments 11-13, further comprising a mixer configured to mix the liquid additives with one or more molding materials.

Embodiment 15 is the system of any one of embodiments 11-14, wherein the additive pump includes a positive displacement pump to deliver the liquid additives under a pressure in the range of about 2000 to 6000 psi.

Embodiment 16 is the system of any one of embodiments 11-15, the injection charging mechanism includes one or more of a screw, a plunger, or a piston.

Embodiment 17 is the system of any one of embodiments 11-16, further comprising a hopper to deliver one or more thermoplastic molding materials into the injection unit.

Embodiment 18 is the system of any one of embodiments 11-17, wherein the additive pump includes an additive dispenser to dispense the liquid additives into the injection unit.

Embodiment 19 is the system of embodiment 18, wherein the additive dispenser comprises:

a liquid container;

a lid for closing the liquid container, the lid comprising an integrated pump cap, the integrated pump cap comprising:

a pump coupled to an intake port to the liquid container;

an output port configured to dispense liquid from the liquid container into the injection unit of the molding system; and

a motor coupler comprising teeth to engage corresponding teeth in a compatible motor base, the motor coupler being rotatable to drive the pump so that contents of the liquid container can be dispensed through the output port.

Embodiment 20 is the system of any one of embodiments 11-19, wherein the one or more liquid additives include a colorant, a plasticizer, a flame retardant, or an adhesion promoter.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Example 1

A syringe pump (obtained under the trade designation “FUSION 6000” from Chemyx, Inc., Stafford, Tex.) was coupled to a 20 mL stainless steel high-pressure syringe (also obtained from Chemyx Inc.) per the manufacturer's recommendations, and stainless steel tubing was used to connect the syringe outlet to the static mixer inlet on an automated fluid dispensing unit for a liquid silicone rubber injection molding machine (obtained under the trade designation “FLUID AUTOMATION LSR” from Graco, Inc., North Canton, Ohio). In this configuration, the LSR part A and B compounds were mixed with an additional additive precisely dosed by the syringe pump. The hardware communicated with a 100 ton injection molding machine (obtained under the trade designation “SODICK LA100SR” from Sodick Injection Molding Machinery Division of Plustech, Schaumburg, Ill.). The screw recovery of the injection molding machine was controlled via a 24-volt control signal, wired to a custom electronics microcontroller (obtained under the trade designation “ARDUINO MEGA” from Amazon.com). The Arduino microcontroller was coded to monitor the screw recovery signal from the injection molding machine and provide dosing instructions to the syringe pump via RS232 protocol.

In this example, reactive materials were precisely dispensed into the static mixer at pressures between 1000 and 1200 psi (6.89 to 8.27 MPa) to control the concentration of reactant in the molded articles. This was accomplished by executing a purging cycle on the injection molding machine and collecting the purge for a defined period of time. Once collected, the mass was divided by the purge time to determine LSR volumetric flowrate during screw recovery/rotation. To maintain additive concentrations of 0.2 to 2%, the additive was dispensed with flowrates ranging between 0.25 to 1.5 mL/min with the syringe pump. The high-pressure capability of the dispensing system allowed the additive to be fed into the mixer against the pressure of the LSR pump. The positive displacement feature of the pump obviated the need for special processes associated with materials-dependent calibrations.

To confirm that the liquid additives were being mixed in the appropriate ratios, samples were collected at the nozzle and analyzed using Si-NMR and Proton NMR. The amount of the additive was calculated based on integration of the areas under the NMR peaks relative to those of the main components.

### Example 2

A generic 12-volt linear string transducer strain gauge (string potentiometer) (obtained from Newark.com) was attached to the screw and barrel of a 100 ton injection molding machine (“SODICK LA100SR”) equipped with a thermoplastic injection barrel. The role of the strain gauge was to provide accurate position, velocity and acceleration data of the screw to a custom software system running on a microcontroller (“Arduino MEGA”) without any need to interpret diagrams and install any electronics within the injection molding machine. During screw feeding, the velocity and acceleration of the strain gauge was opposite to that of the injection direction, therefore the Arduino microcontroller entered dispensing mode. While in dispensing mode, the Arduino microcontroller processed the position, speed, and acceleration data (in accordance with software developed in-house using the Arduino INO programming language) to provide the dynamic flowrate directions and instructions to the dispenser, which pumped fluid additives at appropriately calculated volumetric flow rate, to achieve ideal concentrations of additive (in this case, a colorant). The dispenser used in this example was a part of a commercially available color and dosing system (obtained under the trade designation PINPOINT Express Color and Dosing System from PolyOne, Avon Lake, Ohio). The dispenser was decoupled from its factory controller and wired via RS232 to the Arduino microcontroller instead. The dynamic system self-adjusted, on the fly, from the screw position/velocity/acceleration, with only two operator defined inputs: screw size (diameter), and desired concentration of the additive. This system did not require any direct communication (electrical or otherwise) between the injection molding machine operating system and the dispenser. This, in turn, reduced the complexity of integrating the system, independent of the particular equipment supplier.

Since this was a closed-loop, fast-reacting system, the dispensing of liquids was always precise and adjusted to real-time variations, and it ensured that articles produced during the molding operation had the desired cosmetic and mechanical attributes.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A method of delivering one or more liquid additives to a molding system, comprising:
delivering, via an additive pump, the liquid additives into an injection unit of the molding system, wherein the injection unit includes an injection charging mechanism to charge an injection volume of molding material;
monitoring, via a charging sensor, a status of the injection charging mechanism, to generate a charging status signal representing a charging state of the injection volume of molding material;
processing, via a microcontroller, the charging status signal to generate a dosing instruction to the additive pump; and
controlling, via the additive pump, the delivering of the liquid additives into the injection unit based on the dosing instruction while the injection charging mechanism is charging the injection volume of molding material.

2. The method of claim 1, wherein generating the dosing instruction comprises determining a flowrate of the liquid additives to be delivered into the injection unit.

3. The method of claim 1, wherein the charging sensor includes a strain gauge configured to monitor a position, a velocity, or an acceleration speed of the injection charging mechanism.

4. The method of claim 1, wherein processing the charging status signal further comprises determining the injection volume of the molding material to be charged.

5. The method of claim 1, further comprising mixing, via a mixer, the liquid additives with one or more molding materials, wherein the liquid additives are delivered to the mixer.

6. The method of claim 1, wherein the additive pump includes a positive displacement pump to deliver the liquid additives under a pressure in the range of about 2000 to 6000 psi.

7. The method of claim 1, wherein the injection charging mechanism includes at least one of a screw, a plunger, or a piston, and monitoring the status of the injection charging mechanism further comprises determining whether the screw slips or not.

8. The method of claim 1, further comprising delivering, via a hopper, one or more thermoplastic molding materials into the injection unit.

9. The method of claim 8, wherein the additive pump includes an additive dispenser to dispense the liquid additives into the injection unit.

10. The method of claim 1, wherein the one or more liquid additives include a colorant, a plasticizer, a flame retardant, or an adhesion promoter.

11. A system of delivering one or more liquid additives to a molding system, comprising:
an additive pump configured to deliver the liquid additives into an injection unit of the molding system, wherein the injection unit includes an injection charging mechanism to charge an injection volume of molding material;
a charging sensor configured to monitor a status of the injection charging mechanism and generate a charging status signal; and
a microcontroller to process the charging status signal and generate a dosing instruction to control, via the additive pump, the delivering of the liquid additives into the injection unit based on the dosing instruction.

12. The system of claim 11, wherein the microcontroller determines a flowrate of the liquid additives to be delivered into the injection unit.

13. The system of claim 11, wherein the charging sensor includes a strain gauge configured to monitor a position, a velocity, or an acceleration speed of the injection charging mechanism.

14. The system of claim 11, further comprising a mixer configured to mix the liquid additives with one or more molding materials.

15. The system of claim 11, wherein the additive pump includes a positive displacement pump to deliver the liquid additives under a pressure in the range of about 2000 to 6000 psi.

16. The system of claim 11, the injection charging mechanism includes one or more of a screw, a plunger, or a piston.

17. The system of claim 11, further comprising a hopper to deliver one or more thermoplastic molding materials into the injection unit.

18. The system of claim 11, wherein the additive pump includes an additive dispenser to dispense the liquid additives into the injection unit.

19. The system of claim 18, wherein the additive dispenser comprises:
a liquid container;
a lid for closing the liquid container, the lid comprising an integrated pump cap, the integrated pump cap comprising:
a pump coupled to an intake port to the liquid container;
an output port configured to dispense liquid from the liquid container into the injection unit of the molding system; and
a motor coupler comprising teeth to engage corresponding teeth in a compatible motor base, the motor coupler being rotatable to drive the pump so that contents of the liquid container can be dispensed through the output port.

20. The system of claim 11, wherein the one or more liquid additives include a colorant, a plasticizer, a flame retardant, or an adhesion promoter.
